(19) United States
(12) Patent Application Publication
(10) Pub. No.: US 2026/0134568 A1
(43) Pub. Date: May 14, 2026

(54) Method of Using Artificial Intelligence (AI) for Six Degree-of-Freedom (6D) Object Pose Estimation

(71) Applicant: ABB Schweiz AG, Baden (CH)

(72) Inventors: Jianjun Wang, Apex, NC (US); Biao Zhang, Apex, NC (US); Yi Chen, Raleigh, NC (US); Haoyan Liu, Garner, NC (US)

(73) Assignee: ABB Schweiz AG, Baden (CH)

(21) Appl. No.: 19/445,826

(22) Filed: Jan. 12, 2026

Related U.S. Application Data
(63) Continuation of application No. PCT/IB2023/057337, filed on Jul. 18, 2023.

(51) Int. Cl. G06T 7/70; G06T 7/11; G06T 15/00

(52) U.S. Cl. CPC G06T 7/70; G06T 7/11; G06T 15/00; G06T 2207/20084; G06T 2207/20132

(57) ABSTRACT

A method for estimating 6D poses of objects includes (1) obtaining, using a camera, a low-resolution image and a high-resolution image from a viewpoint of a scene; (2) performing a pose detection on the low-resolution image to obtain class labels, region masks and initial poses of objects in the scene; (3) performing a pose refinement for each of the detected objects on the high-resolution image, including a) generating a cropped image from the high-resolution image based on a region mask of each detected object, and a rendered image of each detected object based on a CAD model, a current pose of each detected object and camera data; b) computing a refined object pose for each of the detected objects by comparing the cropped and rendered images; and c) updating the current pose of each detected object with the refined object pose; and (4) repeating step (3) until fulfilling a criterion.

### CROSS-REFERENCE TO RELATED APPLICATIONS

The present application claims priority to International Patent Application No. PCT/IB20023/057337, filed Jul. 18, 2023, which is incorporated herein in its entirety by reference.

### FIELD

Generally, the present disclosure relates to a six degree-of-freedom (6D) object pose estimation and, more specifically, to a method of using artificial intelligence (AI) for a 6D object pose estimation.

### BACKGROUND

A six degree-of-freedom (6D) object pose estimation is applied in applications of computer vision and robotics to determine a 6D pose of objects in three-dimensional (3D) space. For example, determining a 6D pose of an object in 3D space involves estimating the position and orientation of the object in a scene. In applications such as random bin picking and/or picking and placing, current vision algorithms are sensitive to lighting conditions and object occlusions of a scene. In addition, tuning is necessary for each type of object in the scene. This affects accuracy of 6D object pose estimation of images of the objects in the scene, especially of those objects that are randomly placed or piled up in the scene.

Therefore, there is a need to deal with accuracy of 6D object pose estimation under different lighting conditions, and further, to improve robustness of 6D object pose estimation in various applications.

### SUMMARY

In an exemplary embodiment, the present disclosure provides a method for estimating a six degree-of-freedom (6D) pose of an object in a scene. The method includes (1) obtaining, using a camera, a first image and a second image from a viewpoint of the scene, wherein the second image has a higher resolution than that of the first image; (2) performing a pose detection on the first image to obtain class labels, region masks and initial poses of objects in the scene; (3) performing a pose refinement for each of the detected objects on the second image, wherein the performing the pose refinement includes: a) generating a cropped image from the second image based on a region mask of each detected object, and a rendered image of each detected object based on a computer aided design (CAD) model, a current pose of each detected object and intrinsic and extrinsic data of the camera associated with the second image; b) computing a refined object pose for each of the detected objects by comparing the cropped image and the rendered image; and c) updating the current pose of each detected object with the refined object pose; and (4) repeating step (3) until a criterion is fulfilled.

The obtaining the first image and the second image includes capturing the second image from the viewpoint of the scene through the camera, and downscaling the second image to the first image.

The region mask of each detected object is obtained through the performing the pose detection by: detecting the class labels and bounding boxes of the objects in the first image based on at least one object detection process of the pose detection; and using a bounding box of each detected object as the region mask.

The region mask of each detected object is obtained through the performing the pose detection by: detecting the class labels and instance masks of the objects in the first image based on at least one object detection process of the pose detection; and using an instance mask of each detected object as the region mask.

The region mask of each detected object is obtained through the performing the pose detection by rendering each object with a corresponding CAD model and a current pose of each object.

The performing the pose detection is based on a deep neural network, or multiple deep neural networks that run in sequence or in parallel.

The rendered image of each detected object includes at least one of a color image, a grayscale image, a depth image, a point cloud, or a normalized object coordinate space (NOCS) map.

The computing the refined object pose for each of the detected objects by comparing the cropped image and the rendered image includes: extracting two-dimensional (2D) keypoints on the cropped image and the rendered image; matching the 2D keypoints; locating a three-dimensional (3D) position for each matched 2D keypoint from the rendered image; and applying a perspective-n-point solution for the matched keypoints to compute a refined object pose.

The criterion includes that step (3) is repeated more than a first predefined threshold, or a difference of object poses at two consecutive iterations is less than a second predefined threshold.

The method further includes (5) obtaining a depth image or a point cloud image of the scene; (6) for each detected object, aligning the rendered image with the depth image or the point cloud image to obtain a refined object pose; and (7) outputting the refined object pose for each detected object. The method further includes controlling a robot to perform at least one of bin picking and bin placing based on the refined object pose.

In another exemplary embodiment, the present disclosure provides a method for estimating a six degree-of-freedom (6D) pose of one or more objects in a scene. The method includes:

Obtaining, using one or more cameras, one or more first images from a plurality of viewpoints of the scene; (1) performing a pose detection on the one or more first images from each viewpoint to obtain class labels, region masks and initial poses of objects; (2) matching the detected objects across the plurality of viewpoints; (3) performing a multiview pose triangulation process over poses of each matched object across the plurality of viewpoints to compute a refined object pose using intrinsic and extrinsic data of the one or more cameras associated with the one or more first images from each viewpoint; and outputting the refined object pose of each matched object. The method further includes controlling a robot to perform at least one of bin picking and bin placing based on the refined object pose.

The matching the detected objects across the plurality of viewpoints includes one or more of the following: (1) deciding if the class label of the detected object from each view is the same, (2) computing a Euclidean translational distance of the detected objects from each viewpoint in a common world frame, (3) computing a rotational angular distance of the detected objects from each viewpoint in a common world frame, (4) computing a triangulation pose insistency error metric by performing a multiview pose triangulation process for each matched object.

The performing the multiview pose triangulation process for each matched object includes solving an optimization problem over the refined object pose of each matched object.

The method further includes: (4) obtaining one or more second images from the plurality of viewpoints of the scene, wherein the one or more second images have a higher resolution than that of the one or more first images; (5) refining a pose of each matched object using the one or more second images from each viewpoint by a) generating a cropped image from the one or more second images based on a region mask of each matched object, and a rendered image of each matched object based on a computer aided design (CAD) model, a current pose of each matched object and intrinsic and extrinsic data of the one or more cameras associated with the one or more second images; b) computing a refined object pose of each matched object by comparing the cropped image and the rendered image; and c) updating the current pose with the refined object pose; (6) repeating step (5) multiple iterations until a first criterion is fulfilled; (7) for each matched object, performing a multiview pose triangulation process over updated current poses across the plurality of viewpoints to compute a refined object pose using the intrinsic and extrinsic data of the one or more cameras associated with the one or more second images from each viewpoint; and (8) repeating steps (5)-(7) until a second criterion is fulfilled.

Step (4) the obtaining the one or more second images from the plurality of viewpoints of the scene includes: acquiring a high resolution image through the one or more cameras; downscaling the high resolution image to a low resolution image; using the low resolution image for the steps before step (4); and using the high resolution image for the steps after step (4).

In another exemplary embodiment, the present disclosure provides a device for estimating a six degree-of-freedom (6D) pose of an object in a scene. The device includes one or more processors and is configured to:

(1) obtain a first image and a second image from a viewpoint of the scene, wherein the second image has a higher resolution than that of the first image; (2) perform a pose detection on the first image to obtain class labels, region masks and initial poses of objects in the scene; (3) perform a pose refinement for each of the detected objects on the second image, wherein the performing the pose refinement includes: a) generating a cropped image from the second image based on a region mask of each detected object, and a rendered image of each detected object based on a computer aided design (CAD) model, a current pose of each detected object and intrinsic and extrinsic data of a camera associated with the second image; b) computing a refined object pose for each of the detected objects by comparing the cropped image and the rendered image; and c) updating the current pose of each detected object with the refined object pose; and (4) repeat step (3) until a criterion is fulfilled.

The region mask of each detected object is obtained through the performing the pose detection by: detecting the class labels and bounding boxes of the objects in the first image based on at least one object detection process of the pose detection; and using a bounding box of each detected object as the region mask.

The region mask of each detected object is obtained through the performing the pose detection by: detecting the class labels and instance masks of the objects in the first image based on at least one object detection process of the pose detection; and using an instance mask of each detected object as the region mask.

### BRIEF DESCRIPTION OF THE DRAWING(S)

FIG. 1 is an application of a six degree-of-freedom (6D) object pose estimation method according to an exemplary embodiment of the present disclosure;

FIG. 2 is a schematic diagram of a 6D object pose estimation process or system for a single view according to an exemplary embodiment of the present disclosure;

FIG. 3a is a schematic diagram of a 6D object pose estimation process or system for multiple views according to one exemplary embodiment of the present disclosure;

FIG. 3b is a schematic diagram of a 6D object pose estimation process or system for multiple views according to another exemplary embodiment of the present disclosure;

FIG. 4 is a schematic flowchart of a 6D object pose estimation process for a single view according to an exemplary embodiment of the present disclosure;

FIG. 5a is a schematic flowchart of a 6D object pose estimation process for multiple views according to one exemplary embodiment of the present disclosure;

FIG. 5b is a schematic flowchart of a 6D object pose estimation process for multiple views according to another exemplary embodiment of the present disclosure;

FIG. 5c is a schematic flowchart of a 6D object pose estimation process for multiple views according to another exemplary embodiment of the present disclosure; and

FIG. 6 is a schematic diagram of a device for a 6D object pose estimation process according to an exemplary embodiment of the present disclosure.

### DETAILED DESCRIPTION

Exemplary embodiments of the present disclosure provide a method, device and, non-transitory computer-readable medium for estimating six degree-of-freedom (6D) poses of objects in a scene. The objects in the scene can be of the same class, or from different classes.

Applications of computer vision and robotics, such as bin picking and other picking and placing applications, require robust and accurate 6D object pose estimation of objects in a scene. Robustness and accuracy of 6D object pose estimation become even more important in scenarios in which objects are randomly placed and/or piled up, and ready for picking and placing. The current general practice is a computer-aided design (CAD) model of the object in the scene is given in the format of a three-dimensional (3D) textured or nontextured mesh model for recognizing the object in the scene. Conventional vision algorithms run based on high-resolution images and provide accurate 6D object pose estimation. However, conventional vision algorithms are very sensitive to surrounding lighting conditions, and further, require careful tuning for each type of objects recognized in the scene. Other conventional vision algorithms rely on 3D vision cameras that captures the red, green, blue plus depth (RGBD) information of the scene, however, those vision algorithms often require high end expensive 3D vision cameras in order to achieve high accuracy.

Embodiments of the present disclosure provide a vison algorithm that combines artificial intelligence (AI) based vision with conventional vision. AI based vision techniques may be used for initial object pose detection based on low-resolution images. Conventional vision techniques may be used for object pose refinement based on high-resolution images to achieve higher accuracy. This vision algorithm combining AI based vision with conventional vision addresses robustness and accuracy issues in, for example, random bin picking and other picking and placing applications.

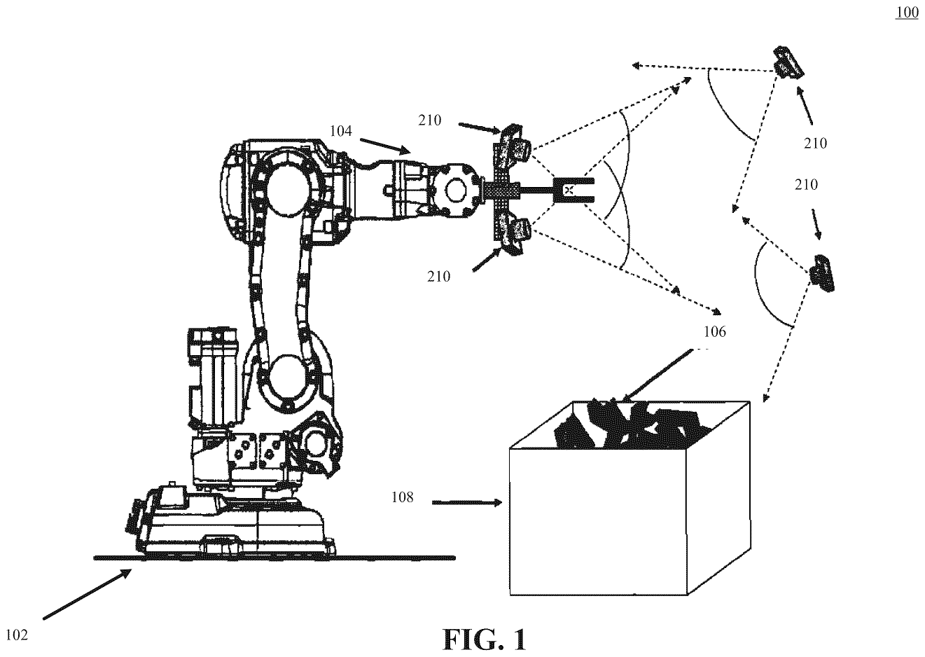

FIG. 1 is an illustrative application of a six degree-of-freedom (6D) object pose estimation method according to an exemplary embodiment of the present disclosure.

Random bin picking and other picking and placing applications ensure a critical milestone for industrial automation processes. These applications enable handling of materials more quickly and efficiently, and provide great flexibility for lifting and feeding components in a production setting. For example, a random bin picking and other picking and placing application 100, as shown in FIG. 1, is able to recognize an item 106 in any orientation and/or in any configuration, select and then place the item 106 in a bin 108 and/or on a pallet in a factory process.

As shown in FIG. 1, such a random bin picking and other picking and placing application 100 employs a robot 102 and a vision system 104. The vision system 104 may be based on various vision techniques. In general, these various vision techniques use one or more cameras with same or different modalities, for example, cameras 210 as shown, to record a two-dimensional (2D) monochrome, color, or depth image of a scene from one or more viewpoints. For example, the orientation and/or configuration of the item 106 are determined based on images of the item 106 from one or more viewpoints captured by the vision system 104. The robot 102 is then commanded to pick the item 106 out of the bin 108 and/or place the item 106 into the bin 108 based on the determined orientation and/or configuration.

In an exemplary embodiment of the present disclosure, artificial intelligence (AI) vision techniques are used in combination with the conventional vision techniques for the vision system 104 of the random bin picking and other picking and placing application 100. The AI vision techniques offer high detection rate and are very robust to surrounding lighting conditions, which overcome the shortcomings of conventional vision techniques. However, AI vision techniques do not offer a highly accurate object pose due to their inefficiency in handling high-resolution images. This shortcoming of AI vision techniques can be overcome by applying the conventional vision techniques to high resolution images. Note that high resolution and low resolution are relative. For example, a 5 MP color image of 2560×1920 pixels is considered high resolution compared to a 0.3 MP color image of 640×480 pixels, but is considered low resolution when compared to a 12 MP color image of 4256×2832. In this disclosure, we will use 5 MP as an example for high resolution, and 0.3 MP as an example for low resolution. As appreciated, this is only for explanation purpose. In no way this should be interpreted as the exact definition of high resolution and low resolution. In an extreme case, the high resolution and low resolution can refer to the same resolution.

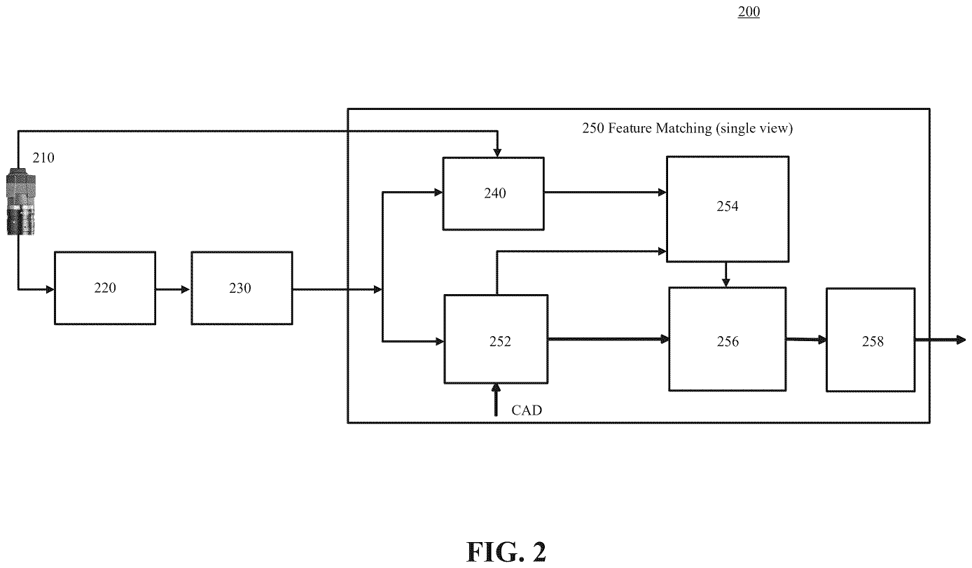

FIG. 2 is a schematic diagram of a 6D object pose estimation process or system for a single view according to an exemplary embodiment of the present disclosure.

As shown in FIG. 2, the vision system 104 of the random bin picking and other picking and placing application 100 of FIG. 1 combines AI based vision with conventional vision and employs one or more cameras 210 for capturing an image from a single viewpoint. The camera 210 is selected to be capable of capturing images with high resolution. For example, the camera 210 may be a 5-megapixel (5 MP) color camera. A 5 MP color camera produces a resolution of 2560×1920 pixels per unit. Additionally and/or alternatively, other cameras, such as grayscale monochrome cameras and/or cameras with different resolutions, may be also used. The captured 5 MP color image from the single viewpoint is then scaled down to an image with a low resolution, as shown in 220 the image downscaling process. For example, the captured 5 MP color image may be scaled down to a 0.3 MP color image from the single viewpoint. The captured 5 MP color image may be also scaled down to an image of a different resolution, such as a 1.2 MP color image or a 2 MP color image from the single viewpoint.

The 0.3 MP low resolution color image from the single viewpoint is then inputted into a 6D pose detection process 230. The output of 230 is a set of pose detections, each containing information of a detected object such as but not limited to class label, position and orientation, and detection confidence score. Additional object information is either directly available from 230 or can be computed, for example, object mask and object boundary. Various approaches are available for the 6D pose detection process. The pose detection process 230 may be either one-stage neural network based pose predictor, or a two-stage pose detection process consisting of an object detection stage and a pose estimation stage.

For a two-stage pose detection process, where an object detector is adopted, in general, an image is input to a deep neural network such as Mask Region-Based Convolutional Neural Network (R-CNN) or You Only Look Once (YOLO) to generate a list of detected objects. The output at least contains information about the identity and the location of each detected object. The object identity may be represented as class label. The object location in the image may be represented as an object region mask indicating the rough region of the image where the object belongs to. The object region mask can be a bounding box, a boundary contour, an instance mask, or other form. The neural network based 2D object detection outputs the class labels and the region masks of possible objects in the 0.3 MP color image from a single viewpoint image. The detected class labels and object region masks are then further processed at the second stage to obtain the poses of all detected objects. As such, the initial poses of these detected objects are estimated.

In a single-stage pose detection process 230, namely the single-stage neural network based pose predictor, the output contains at least class labels, region masks and the poses of all possible objects. In case region masks are not the direct output, they can be computed from the predicted pose and the CAD model of the object. As such, a class label, an object region mask and an initial object pose for each detected object are obtained from the 6D pose detection process 230 for further processes of the captured 5 MP color image and/or scaled down 0.3 MP color image from the single viewpoint.

The initial object pose from the neural network based or AI based pose detection process 230 may not have sufficient accuracy for the application. 250 provides a pose refinement process to improve the pose accuracy by taking advantage of high resolution image using the conventional vision techniques. The pose refinement process 250 takes two types of inputs: the high resolution camera image and the output of pose detection process 230 including class label, region mask and pose of each detected object. The pose refinement process 250 might be applied to each detected object. For each detected object, the object region mask and the captured high resolution 5 MP color image from the single viewpoint are inputted into an image cropping process 240 for cropping out the captured 5 MP color image to obtain a cropped camera image for each detected object. Because the object region mask is obtained from the low resolution 0.3 MP image, it needs to be scaled up for the high resolution 5 MP image. The cropped camera image will have the same pixel density in terms of number of pixels per inch length but smaller image size compared to the high resolution 5 MP camera image. As appreciated, multiple cropped camera images will be obtained, each corresponding to a detected object from 230. In general, the neural network based 6D pose detection process 230 and the image cropping process 240 work on images of different resolutions.

For each detected object, the class label, the object region mask and the initial object pose is input into a rendering process 252 to obtain a rendered object image. The class label is used to find the correct object CAD model from a prestored library of CAD models, if objects in the scene are from different classes having different CAD models. The rendered object image can include a colored image, a monochrome image, a depth image, a point cloud, a normalized object coordinate space (NOCS) map, or other types of images. The rendered object image has the same pixel density as the captured high resolution 5 MP image but a smaller image size. The actual implementation of the rendering process 252 can take a number of optimizations to achieve better computation and memory efficiency. For example, the entire scene of all detected objects can be rendered into one 5 MP scene color image and one 5 MP scene depth image, and then the rendered scene color image and scene depth image are cropped to generate a smaller sized object color image and object depth image for each detected object using object region mask. Alternatively, an object color image and an object depth image of smaller size but the same pixel density as 5 MP captured color image can be directly rendered for each detected object using a smaller field of view defined by the object region mask.

In one exemplary embodiment, the rendered object color image, which has the same pixel density as the high resolution 5 MP captured color image, and the cropped camera image, which is generated from the image cropping process 240 for each detected object, are inputted into a feature extraction and matching process 254. 2D keypoints are extracted in real-time from both of the images, and then, these extracted 2D keypoints are compared with each other to obtain matched 2D corresponding keypoints for each detected object. Various 2d keypoint extraction methods can be used. For higher accuracy, subpixel keypoint extract methods might be used.

Further, these matched 2D keypoints and the rendered high resolution image for each detected object are inputted into a 3D CAD model positioning process 256. In this 3D CAD model positioning process 256, the 3D position for each matched 2D corresponding keypoint on each detected object is computed from the rendered image and the 2D coordinates of the matched 2D corresponding keypoint. To enable such computation, the rendered image can contain a rendered depth image, a rendered point cloud, or a rendered normalized object coordinate space (NOCS) map. The 3D position is with respect to the origin of the CAD model of the detected object.

Furthermore, the 3D locations and 2D image coordinates of all matched 2D corresponding keypoints for each detected object are inputted into a perspective-n-point (PnP) solution process 258 to compute a refined object pose. PnP solutions are commonly used in computer vision to estimate object pose from an image of the object, given a set of 3D points and their corresponding 2D projects in the image. By using high resolution camera image and high resolution rendered image and possibly subpixel feature extraction method, a higher accuracy of object pose can be achieved.

In an exemplary embodiment of the present disclosure, the high resolution pose refinement process 250, which consists of image cropping process 240, rendering process 252, feature extraction and matching process 254, 3D positioning on CAD model process 256, and PnP solution process 258, can be conducted more than one time iteratively until a stopping criterion is reached. The stopping criterion can be the number of iterations, the difference between the object poses from two consecutive iterations less than a preset threshold, or other conditions.

As such, a highly accurate object pose estimation of an image is completed through AI based vision and conventional vision. This object pose estimation is more robust against lighting conditions of the surrounding where the image is taken. This accurate and robust object pose estimation is important for bin picking and/or picking and placing applications, where bins and/or other objects are randomly placed and/or piled up.

FIG. 2 only uses images from one viewpoint of the scene. Although combining AI based vision and conventional vision improves object pose accuracy, relying on single view color image has the accuracy limitation along the camera viewing direction. For example, if the camera view direction is chosen as Z, then a pose estimation process as shown in FIG. 2 will output an object pose with very good accuracy in X and Y, but poor in Z. One way to improve the accuracy in Z is to obtain an additional and possibly high accurate depth image. Using commonly known as Iterative Closest Point (ICP) algorithm, which registers an object CAD model to a depth image or a point cloud given an initial object pose, a better object pose can be obtained. Another way to improve the accuracy in Z is by processing images of the scene from multiple viewpoints and then combining the result from each viewpoint using triangulation principle.

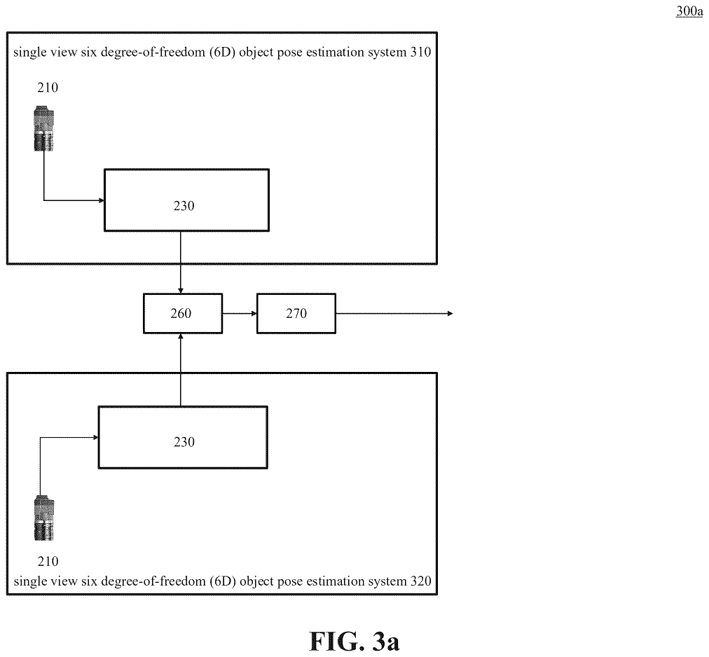

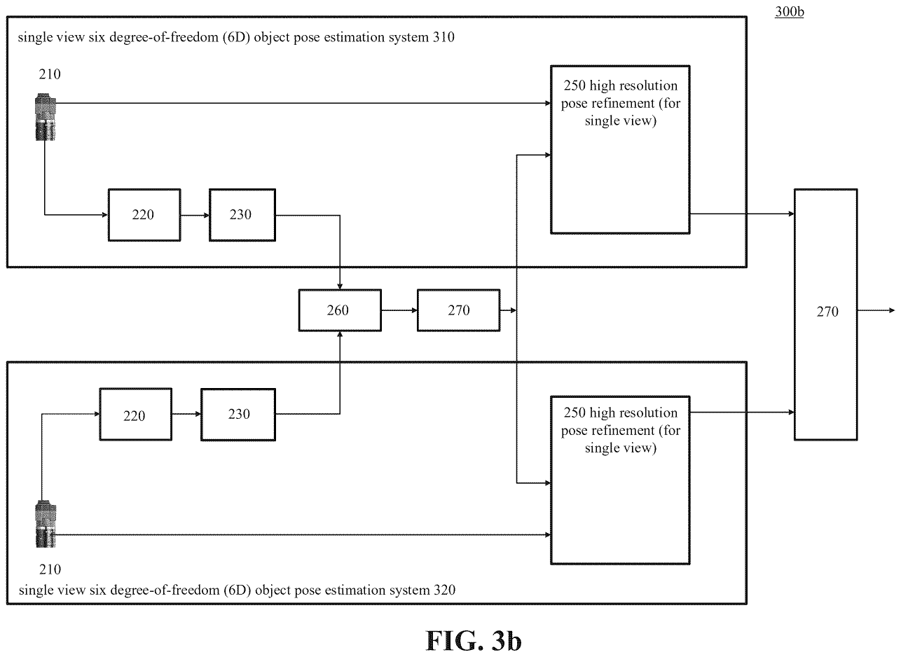

FIG. 3a is a schematic diagram of a 6D object pose estimation process or system for multiple views according to one exemplary embodiment of the present disclosure.

In an exemplary embodiment of the present disclosure as shown in FIG. 3a, two cameras 210 are arranged at two different viewpoints, each associated with a single view object pose estimation system (310 and 320). 310 and 320 can be running in sequence, or mostly in parallel for shorter process time. Note that only two cameras and two single view pose estimation process are shown in FIG. 3a. It should be understood that this is only for explanation purpose. A vision system can have more than two cameras and thus two more single view pose estimation processes. For each pose estimation process (310 or 320) at each viewpoint, the camera captures one or more images. This one or more images is then fed into a pose detection process 230, similar to the one in FIG. 2. The pose detection process 230 outputs a list of pose detections, each containing at least class labels, region masks and initial poses for possible objects in the scene.

Upon the completion by a pose detection process 230 for each camera at each viewpoint, an object correspondence process 260 is conducted. In general, the object correspondence process 260 matches all detected objects across all viewpoints based on information obtained from pose detection process 230 of each single view pose estimation 310 and 320.

The object correspondence process 260 uses a number of matching criteria to determine if a candidate set of detected objects across all viewpoints correspond to the same object instance. The criteria include but are not limited to: a) the same class label, b) the Euclidean distance of the estimated object positions in a common world frame is less than a threshold, c) the difference of the estimation object orientation is less than a threshold, d) the triangulation pose insistency is less than a threshold where the triangulation pose inconsistency is computed by performing a multiview pose triangulation process 270 described further after. The matching criteria can be applied sequentially so that the early applied criteria will filter out improbable correspondence candidates.

For each matched object according to the object correspondence process 260, a multiview pose triangulation process 270 is conducted to refine the object pose. Since the object pose detection process 230 for each view makes one estimation of the object pose, from multiple views a set of object pose estimation is obtained. With calibrated multiviews, that is, the relative positions and orientations of each camera are known, the pose of each matched object can be further improved with triangulation. For each matched object, the multiview pose triangulation process 270 takes a collection of initial estimated poses from each viewpoint, and a collection of camera intrinsic and extrinsic data from each viewpoint to compute a triangulated pose using the triangulation principle. This process also outputs an error metric called the triangulation pose inconsistency indicating the deviation of initial estimated poses of all viewpoints away from the triangulation principle. Triangulation pose inconsistency is a good measure for determining if pose estimates from different viewpoints belong to the same object. It can be used as one of the matching criteria in object correspondence process 260. There are different ways to implement the pose triangulation process 270. One way is to formulate it as an optimization problem:

$$e = {min}_{T} {\sum }_{i , j} ‖ {K}_{i} ( π {T}_{i}^{o} {P}_{j} - {π ( {T}_{i}^{c} )}^{- 1} {TP}_{j} ) ‖$$

Where Tis the triangulated pose for a matched object expressed in the common world frame, {Pⱼ} is the 3D positions of a set of model points expressed in the object model frame,

$${T}_{i}^{o}$$

is the object pose at the ith view with respect to the ith camera frame,

$${T}_{i}^{c}$$

is the extrinsic data of the ith camera defined as the pose of the ith camera frame with respect to the common world frame, π is the camera projection matrix defined as

$$[ \begin{matrix}x \\ y \\ z \\ 1\end{matrix} ] = [ \begin{matrix}x / z \\ y / z \\ 1\end{matrix} ] ,$$

Kᵢ is the intrinsic data of the ith camera defined as

$$[ \begin{matrix}{f}_{x} & {s}_{x} & {p}_{x} \\ {s}_{y} & {f}_{y} & {p}_{y} \\ 0 & 0 & 1\end{matrix} ] ,$$

e is the triangulation pose inconsistency error metric. The model points {Pⱼ} can be any fixed points with known positions with respect to the origin of the object CAD model. For example, they can be eight vertices from a cube of an arbitrarily selected length, or some vertices on the object CAD model surface.

In FIG. 3a camera images are fed into the pose detection process 230. Therefore only one resolution image is needed. When a deep neural network is used in the pose detection process 230, the image resolution is typically low due to the constraint on the hardware and computation time. As such, FIG. 3a can provide good accuracy for object pose estimation, but the accuracy can be limited due to the use of low resolution image.

FIG. 3b is a schematic diagram of a 6D object pose estimation process or system for multiple views according to another exemplary embodiment of the present disclosure. It uses both single view high resolution pose refinement process 250 and multiview pose triangulation process 270 to further improve the object pose accuracy.

Similar to FIG. 3a, two cameras 210 are arranged at two different viewpoints, each associated with a single view object pose estimation system (310 and 320). 310 and 320 can be running in sequence, or mostly in parallel for shorter process time. Note that only two cameras and two single view pose estimation process are shown in FIG. 3b. It should be understood that this is only for explanation purpose. A vision system can have more than two cameras and thus two more single view pose estimation processes. For each pose estimation process (310 or 320) at each viewpoint, the camera captures one or more high resolution images. Through downscaling process 220, one or more low resolution images are obtained at each viewpoint. This one or more low resolution images is then fed into a pose detection process 230, similar to the one in FIG. 2. The pose detection process 230 outputs a list of pose detections, each containing at least class labels, region masks and initial poses for possible objects in the scene.

Upon the completion by a pose detection process 230 for each camera at each viewpoint, an object correspondence process 260 is conducted, followed by a multiview pose triangulation process 270 to compute a refined object pose for each matched object in the scene. The processes 230, 260, 270 in FIG. 3b are similar to the ones in FIG. 3a except dealing with low resolution images.

For each matched object, the refined object pose from the multiview pose triangulation process 270 is then converted to the camera coordinate frame for each viewpoint. At each viewpoint, the high resolution image obtained from this viewpoint, together with the new object pose, object class label and object region mask is fed into the high resolution pose refinement process 250 to compute another refined object pose which has even better accuracy. The high resolution refinement process 250 is performed independently at and for each viewpoint for each matched object. Similar to FIG. 2, the high resolution pose refinement process 250, consists of image cropping process 240, rendering process 252, feature extraction and matching process 254, 3D positioning on CAD model process 256, and PnP solution process 258. It can be conducted more than one time iteratively until a stopping criterion is reached. The stopping criterion can be the number of iterations, the difference between the object poses from two consecutive iterations less than a preset threshold, or some other conditions.

For each matched object, the collection of the new object poses obtained at each viewpoint from high resolution pose refinement process 250 is then input to another multiview pose triangulation process 270 to compute another triangulated pose. The triangulated object pose can be then output as the final object pose for each matched object.

The single view high resolution pose refinement process 250 and multiview pose triangulation process 270 can be repeated one or more times until reaching another stopping criterion. The stopping criterion can be the number of iterations, or the difference between the object poses from two consecutive iterations less than a preset threshold, or some other conditions.

In general, FIG. 3b uses a series of possibly repeating pose refinement processes to improve the initial poses obtained from pose detection process 230. The pose refinement process can be a single view high resolution refinement process 250 or a multiview pose triangulation process 270.

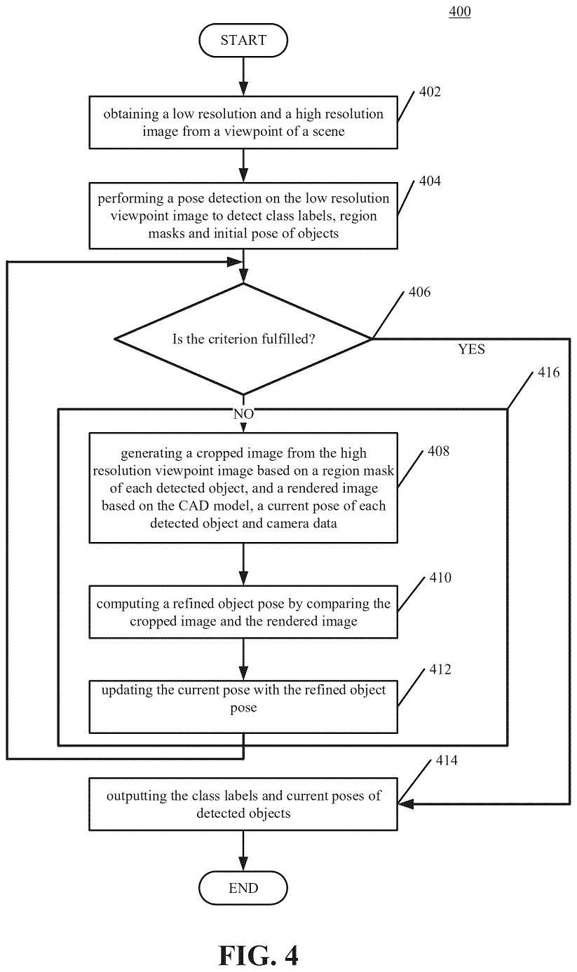

FIG. 4 is a schematic flowchart of a 6D object pose estimation process for a single view according to an exemplary embodiment of the present disclosure.

As shown, a process or method for a 6D object pose estimation for a single view 400 includes the following steps:

At 402, a device obtains a low resolution image and a high resolution image from a viewpoint of a scene.

The device generally includes one or more processors that execute a process or method for a 6D object pose estimation.

The low resolution and high resolution image might be acquired both directly from the camera. Alternatively, a high resolution image might be acquired from the camera, then is downscaled to create a low resolution image.

At 404, the device performs a pose detection process on the low resolution viewpoint image to detect class labels, region masks and initial poses of objects in the scene.

The pose detection is performed based on a neural network pose detection model. Before performing the pose detection, the viewpoint image is scaled down. For example, the viewpoint image may be scaled down from a 5 MP color image to a 0.3 MP color image. Additionally and/or alternatively, other resolutions of the viewpoint image may be used.

At 406, the device determines whether a criterion is fulfilled.

The criterion includes whether the processes of the high resolution viewpoint image have been repeated more than a first predefined threshold and/or whether a difference of object poses at two consecutive iterations is less than a second predefined threshold. Additionally and/or alternatively, other criteria may also apply. The processes of the high resolution viewpoint image, designated as 416 in FIG. 4, include steps 408, 410, and 412 introduced below.

If the criterion is fulfilled, the device outputs the class labels and current poses of detected objects, as shown at 414 of FIG. 4. Accordingly, the 6D object pose estimation process for the single view ends.

If the criterion is not fulfilled, the processes of the high resolution viewpoint image 416 start. These processes 416 include the following steps:

At 408, the device generates a cropped image and a rendered image.

The cropped image is generated by cropping out the high resolution viewpoint image based on the region mask of each detected object. The rendered image is generated by using an object CAD model, a current pose of each detected object and the intrinsic and extrinsic data of the camera associated with the high resolution image. The rendered image may include a rendered high resolution color image and a rendered high resolution depth image, and/or high resolution NOCS image.

At 410, the device computes a refined object pose for each detected object in the high resolution viewpoint image by comparing the cropped image and the rendered image.

The process of computing a refined object pose for each detected object in the high resolution viewpoint image may include extracting 2D keypoints on the cropped image and the rendered image, matching the 2D keypoints, locating a 3D position for each matched 2D keypoint from the rendered image, and solving a view PnP equation.

At 412, the device updates the current pose of each detected object with the refined object pose.

Then, the device determines again at 406 whether the criterion is fulfilled.

If the criterion is fulfilled, the device outputs the class labels and current poses of detected objects, as shown at 414 of FIG. 4. Accordingly, the 6D object pose estimation process for the single view ends. The device then controls a robot, for example, the robot 102 as shown in FIG. 1, to perform bin picking and/or bin placing based on the outputted data (e.g., the refined object pose). For example, the device provides one or more instructions to control the robot (e.g., robot 102) such as by selecting and placing an item (e.g., item 106) into a bin (e.g., bin 108) and/or on a pallet in a factory process.

If the criterion is not fulfilled, the processes of the high resolution viewpoint image 416 repeat.

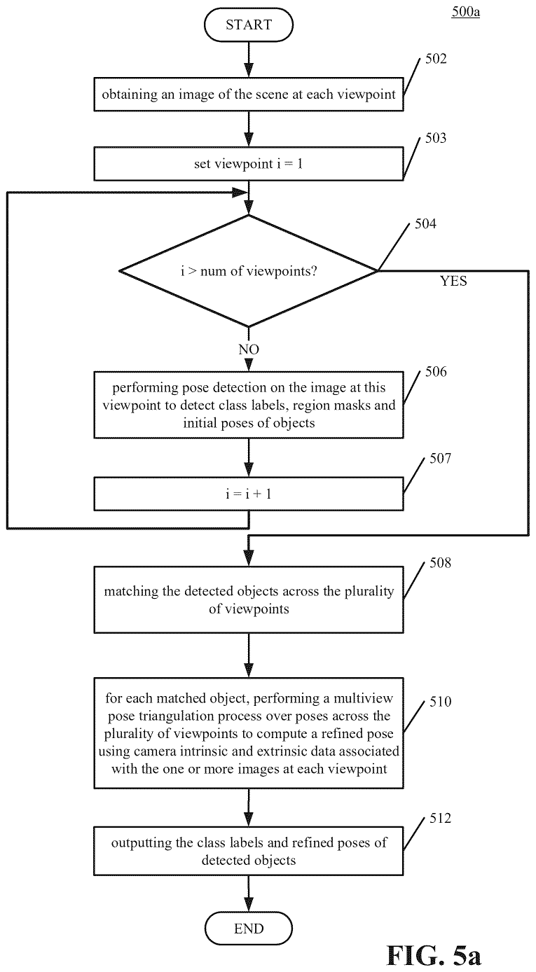

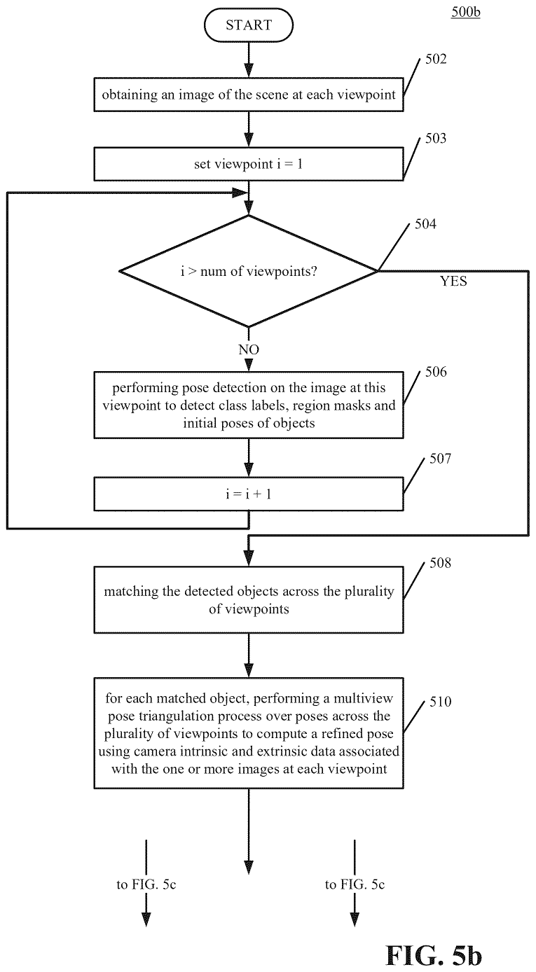

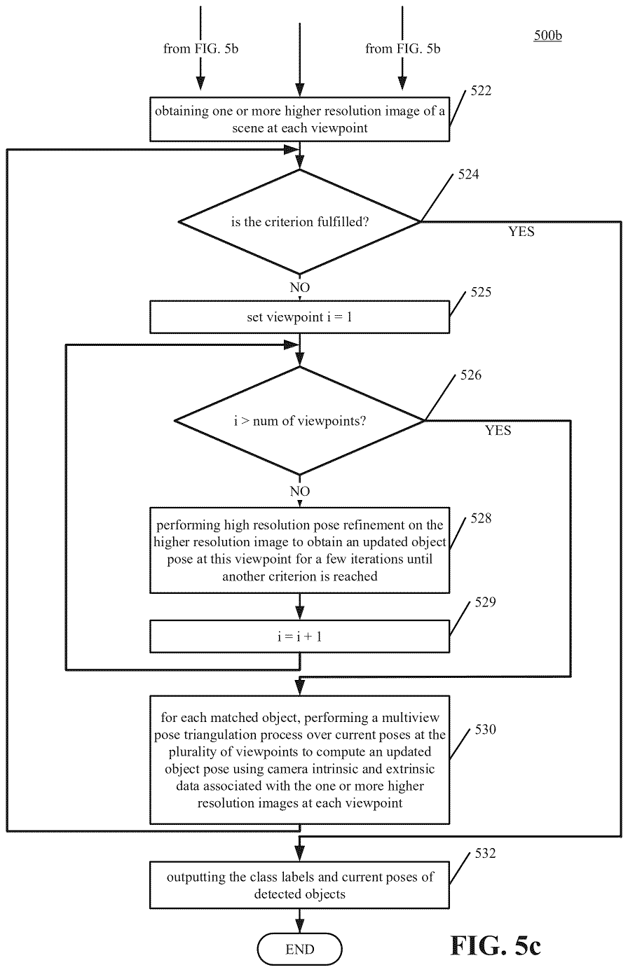

FIG. 5a is a schematic flowchart of a 6D object pose estimation process for multiple views according to one exemplary embodiment of the present disclosure.

As shown, a process or method for a 6D object pose estimation for multiple views 500a includes the following steps:

At 502, a device acquires one or more images from a plurality of viewpoints of a scene. In an exemplary embodiment, at least one image of the scene at each viewpoint is obtained.

The one or more images from the plurality of viewpoints of the scene may be provided as an input from an external device. Additionally and/or alternatively, the one or more images from the plurality of viewpoints of the scene may be taken by an integrated camera.

At 506, the device performs a pose detection on an image of the scene at each viewpoint to detect class labels, region masks and initial poses of objects.

The steps 503, 504, and 507 make sure one or more images at each viewpoint are processed by the pose detection at 506.

At 508, the device matches the detected objects across the plurality of viewpoints once all images at each viewpoint are processed by the pose detection at 506.

At 510, the device performs a multiview pose triangulation process over a collection of poses of each matched object at the plurality of viewpoints to compute a refined object pose using intrinsic and extrinsic data of the camera associated with the one or more images from each viewpoint.

At 512, the device outputs the class labels and refined object pose of each matched object. The device then controls a robot, for example, the robot 102 as shown in FIG. 1, to perform bin picking and/or bin placing based on the outputted data (e.g., the refined object pose). For example, the device provides one or more instructions to control the robot (e.g., robot 102) such as by selecting and placing an item (e.g., item 106) into a bin (e.g., bin 108) and/or on a pallet in a factory process.

FIG. 5b and FIG. 5c show a schematic flowchart of a 6D object pose estimation process for multiple views according to another exemplary embodiment of the present disclosure.

A process or method for a 6D object pose estimation for multiple views 500b includes the following steps:

As shown in FIG. 5b, the steps 502, 503, 504, 506, 507, 508, and 510 are the same as the ones shown in FIG. 5a.

The further steps of the process or method for a 6D object pose estimation for multiple views 500b shown in FIG. 5c include:

At 522, the device acquires one or more high resolution images from the plurality of viewpoints of the scene. In an exemplary embodiment, at least one high resolution image of the scene at each viewpoint is obtained.

At 524, the device determines whether a first criterion is fulfilled.

In an exemplary embodiment, the first criteria includes a difference between object poses from two consecutive iterations being less than a preset threshold. Additionally and/or alternatively, other criteria may also apply.

If the first criterion is fulfilled, the device outputs the class labels and the current poses of detected objects at 532.

If the first criterion is not fulfilled, the device performs the high resolution pose refinement on a high resolution image at each viewpoint at 528 to obtain an updated object pose. The device repeats the high resolution pose refinement at 528 one or more iterations for each viewpoint until a second criterion is fulfilled.

In an exemplary embodiment, the second criterion includes the number of iterations being more than a preset threshold. Additionally and/or alternatively, other criteria may also apply.

The steps 525, 526, and 529 make sure one or more images at each viewpoint are processed by the high resolution pose refinement at 528. Once the device processes the high resolution pose refinement on all images at each viewpoint at 528, the process or method for a 6D object pose estimation for multiple views 500b continues as follows:

At 530, the device performs a multiview pose triangulation process over a collection of current poses of each matched object at the plurality of viewpoints to compute an updated object pose using intrinsic and extrinsic data of the camera associated with the one or more high resolution images from each viewpoint.

The device repeats the multiview pose triangulation process at 530 until the first criterion is fulfilled.

At 532, the device outputs the class labels and current poses of detected objects once the first criterion is fulfilled. The device then controls a robot, for example, the robot 102 as shown in FIG. 1, to perform bin picking and/or bin placing based on the outputted data (e.g., the refined object pose). For example, the device provides one or more instructions to control the robot (e.g., robot 102) such as by selecting and placing an item (e.g., item 106) into a bin (e.g., bin 108) and/or on a pallet in a factory process.

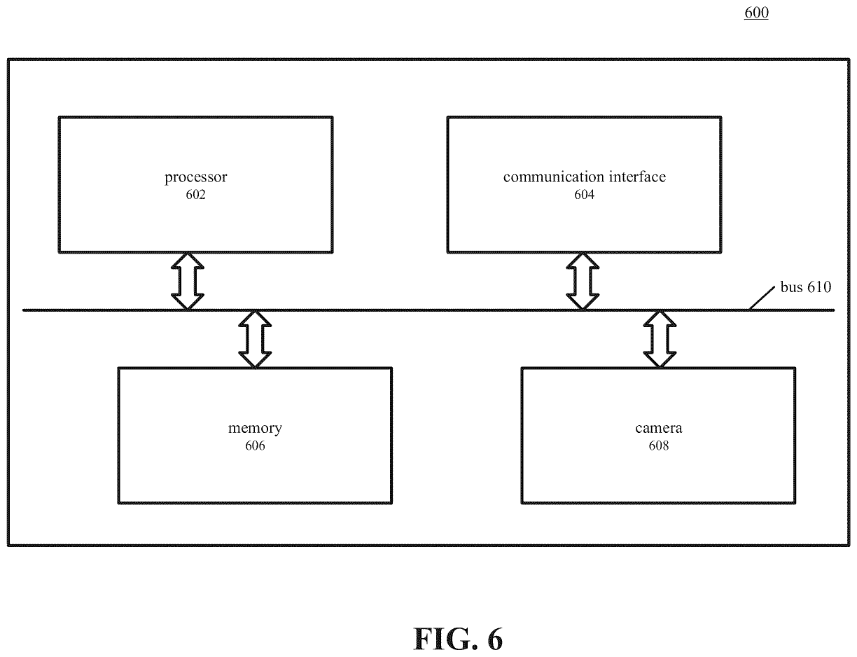

FIG. 6 is a schematic diagram of a device for performing a 6D object pose estimation process according to an exemplary embodiment of the present disclosure.

As shown in FIG. 6, a device 600 for performing a 6D object pose estimation using AI based vision techniques and conventional vision techniques may include a bus 610, a processor 602, a communication interface 604 and a memory 606. Additionally and/or alternatively, the device 600 may further include a camera 608. For example, the processor 602, the communication interface 604, the memory 606 and the camera 608 may communicate with each other through the bus 610.

The processor 602 may include one or more general-purpose processors, such as a central processing unit (CPU), a graphic process unit (GPU) or tensor process unit (TPU), or a combination of a CPU, a GPU or a TPU and a hardware chip. The hardware chip may be an application-specific integrated circuit (ASIC), a programmable logic device (PLD), or a combination thereof. The PLD may be a complex programmable logic device (CPLD), a field-programmable gate array (FPGA), generic array logic (GAL), or any combination thereof.

The memory 606 may include a volatile memory, for example, a random access memory (RAM). The memory 606 may further include a non-volatile memory (NVM), for example, a read-only memory (ROM), a flash memory, a hard disk drive (HDD), or a solid-state drive (SSD). The memory 606 may further include a combination of the foregoing-discussed types.

The memory 606 may have computer-readable program codes stored thereon. The processor 602 may read the computer-readable program codes stored on the memory 606 to perform the 6D object pose estimation for a single view and/or multiple views, as shown in FIGS. 2 and 3a-3b and described above. The processor 602 may also read the computer-readable program codes stored on the memory 606 to implement the methods 400 of FIGS. 4 and/or 500a of FIG. 5a and/or 500b of FIGS. 5b and 5c described above to perform the 6D object pose estimation for a single view and/or multiple views. Additionally and/or alternatively, the processor 602 may read the computer-readable program codes stored on the memory 606 to implement one or more other functions, and/or a combination of these functions.

The processor 602 may further communicate with another computing device through the communication interface 604. For example, the processor 602 may communicate with another computing device to obtain a preset value and/or a threshold to determine whether an estimated object pose for a single view and/or multiple views are sufficiently satisfying. For example, the processor 602 may communicate with an external camera to obtain captured images from a single viewpoint and/or from multiple viewpoints of a scene.

The processor 602 may further trigger the camera 608 to capture an image from a viewpoint of a scene for a 6D object pose estimation of a single view. The processor 602 may also trigger the camera 608 to capture at least one image from each n viewpoint of a scene, with n being an integer and larger than 1, for a 6D object pose estimation of multiple views.

A person of ordinary skill in the art will appreciate that the device 600 as shown in FIG. 6 may communicate with one or more further computing devices through the communication interface 604 or wireless connections for further functions, and/or a combination of functions. The device 600 may also include one or more further functional components to perform and/or trigger further functions, or a combination of functions.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Exemplary embodiments of the present disclosure are described herein, including the best mode known to the inventors for carrying out the disclosure. Variations of those exemplary embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A method for estimating six degree-of-freedom (6D) poses of one or more objects in a scene, comprising:
(1) obtaining, using a camera, a first image and a second image from a viewpoint of the scene, wherein the second image has a higher resolution than that of the first image;
(2) performing a pose detection on the first image to obtain class labels, region masks and initial poses of objects in the scene;
(3) performing a pose refinement for each of the detected objects on the second image, wherein the performing the pose refinement comprises:
a) generating a cropped image from the second image based on a region mask of each detected object, and a rendered image of each detected object based on a computer aided design (CAD) model, a current pose of each detected object and intrinsic and extrinsic data of the camera associated with the second image;
b) computing a refined object pose for each of the detected objects by comparing the cropped image and the rendered image; and
c) updating the current pose of each detected object with the refined object pose; and
(4) repeating step (3) until a criterion is fulfilled.

2. The method of claim 1, wherein the obtaining the first image and the second image comprises capturing the second image from the viewpoint of the scene through the camera, and downscaling the second image to the first image.

3. The method of claim 1, wherein the region mask of each detected object is obtained through the performing the pose detection by:
detecting the class labels and bounding boxes of the objects in the first image based on at least one object detection process of the pose detection; and
using a bounding box of each detected object as the region mask.

4. The method of claim 1, wherein the region mask of each detected object is obtained through the performing the pose detection by:
detecting the class labels and instance masks of the objects in the first image based on at least one object detection process of the pose detection; and
using an instance mask of each detected object as the region mask.

5. The method of claim 1, wherein the region mask of each detected object is obtained through the performing the pose detection by rendering each object with a corresponding CAD model and a current pose of each object.

6. The method of claim 1, wherein the performing the pose detection is based on a deep neural network, or multiple deep neural networks that run in sequence or in parallel.

7. The method of claim 1, wherein the rendered image of each detected object comprises at least one of a color image, a grayscale image, a depth image, a point cloud, or a normalized object coordinate space (NOCS) map.

8. The method of claim 1, wherein the computing the refined object pose for each of the detected objects by comparing the cropped image and the rendered image comprises:
extracting two-dimensional (2D) keypoints on the cropped image and the rendered image;
matching the 2D keypoints;
locating a three-dimensional (3D) position for each matched 2D keypoint from the rendered image; and
applying a perspective-n-point solution for the matched keypoints to compute a refined object pose.

9. The method of claim 1, wherein the criterion comprises that step (3) is repeated more than a first predefined threshold, or a difference of object poses at two consecutive iterations is less than a second predefined threshold.

10. The method of claim 1, further comprising:
(5) obtaining a depth image or a point cloud image of the scene;
(6) for each detected object, aligning the rendered image with the depth image or the point cloud image to obtain a refined object pose; and
(7) outputting the refined object pose for each detected object.

11. The method of claim 10, wherein the outputting the refined object pose for each detected object comprises:
controlling a robot to perform at least one of bin picking and bin placing based on the refined object pose.

12. A method for estimating a six degree-of-freedom (6D) pose of one or more objects in a scene, comprising:
obtaining, using one or more cameras, one or more first images from a plurality of viewpoints of the scene;
(1) performing a pose detection on the one or more first images from each viewpoint to obtain class labels, region masks and initial poses of objects;
(2) matching the detected objects across the plurality of viewpoints;
(3) performing a multiview pose triangulation process over poses of each matched object across the plurality of viewpoints to compute a refined object pose using intrinsic and extrinsic data of the one or more cameras associated with the one or more first images from each viewpoint; and
outputting the refined object pose of each matched object.

13. The method of claim 12, wherein the outputting the refined object pose of each matched object comprises:
controlling a robot to perform at least one of bin picking and bin placing based on the refined object pose.

14. The method of claim 12, wherein the matching the detected objects across the plurality of viewpoints comprises one or more of the following: (1) deciding if the class label of the detected object from each view is the same, (2) computing a Euclidean translational distance of the detected objects from each viewpoint in a common world frame, (3) computing a rotational angular distance of the detected objects from each viewpoint in a common world frame, (4) computing a triangulation pose insistency error metric by performing a multiview pose triangulation process for each matched object.

15. The method of claim 14, wherein the performing the multiview pose triangulation process for each matched object comprises solving an optimization problem over the refined object pose of each matched object.

16. The method of claim 12, further comprising:
(4) obtaining, using the one or more cameras, one or more second images from the plurality of viewpoints of the scene, wherein the one or more second images have a higher resolution than that of the one or more first images;
(5) refining a pose of each matched object using the one or more second images from each viewpoint by
a) generating a cropped image from the one or more second images based on a region mask of each matched object, and a rendered image of each matched object based on a computer aided design (CAD) model, a current pose of each matched object and intrinsic and extrinsic data of the one or more cameras associated with the one or more second images;
b) computing a refined object pose of each matched object by comparing the cropped image and the rendered image; and
c) updating the current pose with the refined object pose;
(6) repeating step (5) multiple iterations until a first criterion is fulfilled;
(7) for each matched object, performing a multiview pose triangulation process over updated current poses across the plurality of viewpoints to compute a refined object pose using the intrinsic and extrinsic data of the one or more cameras associated with the one or more second images from each viewpoint; and
(8) repeating steps (5)-(7) until a second criterion is fulfilled.

17. The method of claim 16, wherein step (4) the obtaining the one or more second images from the plurality of viewpoints of the scene comprises:
acquiring a high resolution image through the camera;
downscaling the high resolution image to a low resolution image;
using the low resolution image for the steps before step (4); and
using the high resolution image for the steps after step (4).

18. A device for estimating a six degree-of-freedom (6D) pose of one or more objects in a scene, wherein the device comprises one or more processors, and wherein the device is configured to:
(1) obtain a first image and a second image from a viewpoint of the scene, wherein the second image has a higher resolution than that of the first image;
(2) perform a pose detection on the first image to obtain class labels, region masks and initial poses of objects in the scene;
(3) perform a pose refinement for each of the detected objects on the second image, wherein the performing the pose refinement comprises:
a) generating a cropped image from the second image based on a region mask of each detected object, and a rendered image of each detected object based on a computer aided design (CAD) model, a current pose of each detected object and intrinsic and extrinsic data of a camera associated with the second image;
b) computing a refined object pose for each of the detected objects by comparing the cropped image and the rendered image; and
c) updating the current pose of each detected object with the refined object pose; and
(4) repeat step (3) until a criterion is fulfilled.

19. The device of claim 18, wherein the region mask of each detected object is obtained through the performing the pose detection by:
detecting the class labels and bounding boxes of the objects in the first image based on at least one object detection process of the pose detection; and
using a bounding box of each detected object as the region mask.

20. The device of claim 18, wherein the region mask of each detected object is obtained through the performing the pose detection by:
detecting the class labels and instance masks of the objects in the first image based on at least one object detection process of the pose detection; and
using an instance mask of each detected object as the region mask.
